(19) United States
(12) Patent Application Publication
(10) Pub. No.: US 2016/0184705 A1
(43) Pub. Date: Jun. 30, 2016

(54) Method for sending webgame message and browser thereof and webgame service server

(71) Applicant: BEIJING QIHOO TECHNOLOGY COMPANY LIMITED, Beijing, CN (US)

(72) Inventors: Juyuan Zhang, BEIJING (CN); Huan Ren, BEIJING (CN)

(21) Appl. No.: 14/442,532

(22) PCT Filed: Sep. 17, 2013
(86) PCT No.: PCT/CN2013/083654

§ 371 Date: May 13, 2015

(30) Foreign Application Priority Data
Nov. 14, 2012 (CN) 201210458481.1

(51) Int. Cl. A63F 13/35; A63F 13/79

(52) U.S. Cl. CPC A63F 13/35; A63F 13/79

(57) ABSTRACT

The disclosure discloses a method for sending a webgame message and a browser thereof, a webgame service server, and a system for sending a message in a webgame. Therein, the method for a browser to send a webgame message comprises the steps of: starting a webgame message plug-in at the browser side; logging in a webgame service server via the webgame message plug-in according to login information of a browser user; the webgame message plug-in obtaining webgame game information of the browser user from the logged-in webgame service server side; and the webgame message plug-in sending a webgame message input at the browser side to the logged-in webgame service server side according to the webgame game information of the browser user. By utilizing the solution of the disclosure, it can be realized that a browser user can receive a webgame message from other game player without logging in a game server, which greatly improves the user's experience.

### FIELD OF THE INVENTION

The disclosure relates to the field of internet technologies, and in particular, to a method for sending a webgame message and a browser thereof and a webgame service server.

### BACKGROUND OF THE INVENTION

A webgame is also called a Web game, or a clientless online game, for short, webgame. It is a network online multiplayer interactive game based on a Web browser, there is no need for downloading a client, it is only necessary to open an IE webpage and take 10 seconds to enter the game, there is no problem of an insufficient configuration of a machine, and above all, close or switch of the webgame is extremely convenient, which is especially suitable for the office workers.

The mainstream types of the webgame are: action role-playing ARPG (rep.: Decade sword), strategy type SLG (rep.: Thirty-six strategems), and management simulation SIM (rep.: Grand Master), etc.

WebGame, just as the name suggests, is a network online multiplayer game based on a Web browser. Developing from its birth till now, WebGame is roughly divided into three types: the first one is a virtual community constructed by using an interpretive language such as PHP/ASP/Perl, etc. based on a Web browser; the second one is a game produced by using the Flash/JAVA technique based on a Web browser; and the third one is a game for which it is needed to download a client and connect it to a dedicated server for operation (e.g., Tencent's games).

In a webgame, there is mutual information transmission between game players or information transmission in a specific group of players. FIGS. 1A and 1B are schematic drawings of interfaces of a browser webgame, which relies on a browser page for playing a game. FIG. 1B shows information transmission between players of for example a camp, a fairy league group.

FIG. 2 is an existing schematic diagram of webpage players sending information to each other. Referring to FIG. 2, when a player uses a browser to play a page game, it is generally after he logs in the page game that a communication connection (a connection of the HTTP or TCP protocol) with a webgame server will be established to transmit the login information, the identity information of the player and information in a group. Thus, the sending and obtaining of information in the group after player users log in a game server may be realized, for example, the boss within the group appoints to go together to play at 7 p.m. on the right day, convenes members within the group, and sends out notification information to individual players.

The drawbacks present in the prior art are that when a user is using a browser, he must first log in a webgame server, open an interface of a webgame, and then can send information within his own group of game players via a game server, and as such, the experience of the user is not good. It is impossible to transmit a message between webgame users in the browser in a non-login state of the webgame. Yet in the procedure of installing and invoking an ActiveX plug-in in the prior art, it is possible to encounter the instability of a computer system, and in turn affect the experience of a user when the user is using a browser to browse a webpage. Therefore, there is a need for a method which avoids using an ActiveX plug-in installed in a computer system and implements an ActiveX plug-in embedded in a browser, thereby improving the stability of the computer system and the experience of a user.

### SUMMARY OF THE INVENTION

In view of the above problems, the disclosure is proposed to provide a method for sending a webgame message and a browser thereof, a webgame service server, a system and program for sending a message in a webgame which can overcome the above problems or at least in part solve or mitigate the above problems.

According to an aspect of the disclosure, there is provided a method for a browser to send a webgame message comprising: starting a webgame message plug-in at the browser side; logging in a webgame service server via the webgame message plug-in according to login information of a browser user; the webgame message plug-in obtaining webgame game information of the browser user from the logged-in webgame service server side; and the webgame message plug-in sending a webgame message input at the browser side to the logged-in webgame service server side according to the webgame game information of the browser user.

Correspondingly, according to another aspect of the disclosure, the disclosure further provides a browser comprising: a webgame message plug-in starting device configured to start a webgame message plug-in at the browser side; a login device configured to log in a webgame service server via the webgame message plug-in according to login information of a browser user; a webgame game information obtaining device configured to obtain webgame game information of the browser user via the webgame message plug-in from the logged-in webgame service server side; and an information sending device configured to, according to the webgame game information of the browser user, send a webgame message input at the browser side via the webgame message plug-in to the logged-in webgame service server side.

Correspondingly, according to a further aspect of the disclosure, the disclosure further provides a method for a webgame service server to distribute a webgame message comprising the steps of: receiving login information of a browser user sent by a browser side, and logging in the webgame service server according to the login information; synchronizing webgame game information of the browser user with a game server according to the browser user identification corresponding to the login information of the browser user; synchronizing the synchronously obtained webgame game information of the browser user to the browser side which logs in the webgame service server; and receiving a webgame message sent by the browser side which logs in the webgame service server, and sending the webgame message to a corresponding target browser side according to the webgame game information of the browser user.

Correspondingly, according to a further aspect of the disclosure, the disclosure further provides a webgame service server comprising: a login information authentication unit configured to receive login information of a browser user sent by a browser side and authenticate it, and allow the browser user to log in after the authentication is passed; a synchronization unit configured to synchronize webgame game information of the browser user with a game server according to the browser user identification corresponding to the login information of the browser user, and synchronize the synchronously obtained webgame game information of the browser user to the browser side which logs in the webgame service server; and a message distribution unit configured to receive a webgame message sent by the browser side which logs in the webgame service server, and send the webgame message to a corresponding target browser side according to the webgame game information of the browser user.

Correspondingly, according to a further aspect of the disclosure, the disclosure further provides a system for sending a message in a webgame comprising: a browser configured to log in a webgame service server, obtain webgame game information of a browser user from the logged-in webgame service server side, input a webgame message and send it to the logged-in webgame service server side according to the webgame game information of the browser user; the webgame service server configured to receive login information of the browser user sent by the browser side and authenticating it, allow the browser user to log in after the authentication is passed, synchronize webgame game information of the browser user with a game server according to the browser user identification corresponding to the login information of the browser user, and synchronize the synchronously obtained webgame game information of the browser user to the browser side which logs in the webgame service server, receive a webgame message sent by the browser side which logs in the webgame service server, and send the webgame message to a corresponding target browser side according to the webgame game information of the browser user; and the game server configured to synchronize the webgame game information of the user to the webgame service server in real time.

According to yet another aspect of the disclosure, there is provided a computer program comprising a computer readable code which causes a browser user terminal to perform the method for a browser to send a webgame message according to any of claims 1-13, and/or causes a webgame service server to perform the method for a webgame service server to distribute a webgame message according to any of claims 27-40, when said computer readable code is running on the browser user terminal/webgame service server.

According to still another aspect of the disclosure, there is provided a computer readable medium storing the computer program as claimed in claim 56 therein.

The beneficial effects of the disclosure lie in that: by utilizing the solution of the disclosure, it can be realized that for a browser user, a group of game players in his browser game can send a webgame message to other player even without logging in the webgame, and the browser user can receive a webgame message from other game player without logging in a game server, which greatly improves the user's experience.

The above description is merely an overview of the technical solutions of the disclosure. In the following particular embodiments of the disclosure will be illustrated in order that the technical means of the disclosure can be more clearly understood and thus may be embodied according to the content of the specification, and that the foregoing and other objects, features and advantages of the disclosure can be more apparent.

### BRIEF DESCRIPTION OF THE DRAWINGS

Various other advantages and benefits will become apparent to those of ordinary skills in the art by reading the following detailed description of the preferred embodiments. The drawings are only for the purpose of showing the preferred embodiments, and are not considered to be limiting to the disclosure. And throughout the drawings, like reference signs are used to denote like components. Therein:

FIGS. 1A and 1B are schematic drawings of interfaces of a browser webgame;

FIG. 2 is a schematic diagram of sending information between individual players in a browser webgame in the prior art;

FIG. 3 is a flow chart of a method for a browser to send a webgame message according to an embodiment of the disclosure;

FIG. 4A is an illustration of an interface for inputting a webgame message according to received webgame game information at a browser side of the disclosure;

FIG. 4B is an illustration of an interface for receiving a webgame message and prompting it at a browser side of the disclosure;

FIG. 5 is a structural block diagram of a browser according to an embodiment of the disclosure;

FIG. 6 is a flow chart of a method for a webgame service server to distribute a webgame message according to an embodiment of the disclosure;

FIG. 7 is a structural block diagram of a webgame service server according to an embodiment of the disclosure;

FIG. 8 is a structural block diagram of a system for sending a message in a webgame;

FIG. 9 shows a block diagram of a browser user terminal device/webgame service server which can realize sending a webgame message according to an embodiment of the disclosure; and

FIG. 10 shows schematically a storage unit for retaining or carrying a program code implementing a method according to the disclosure.

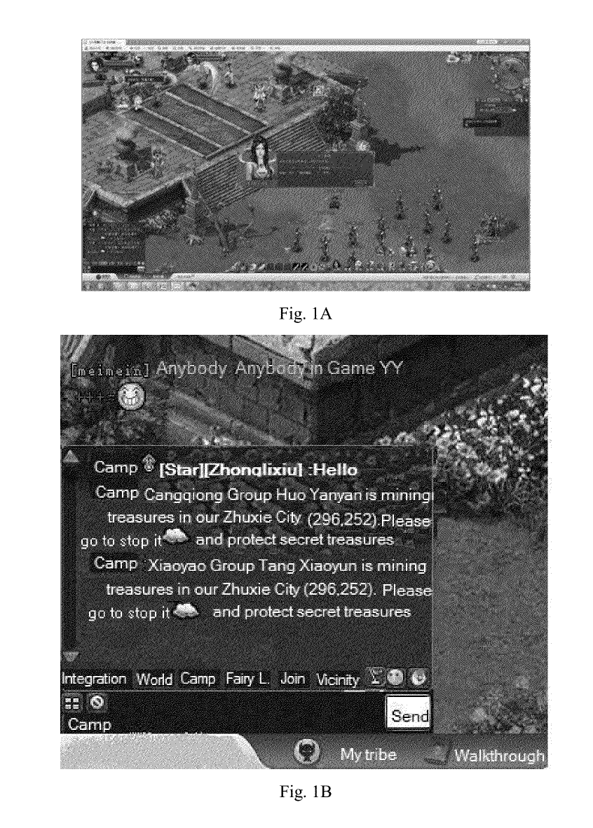

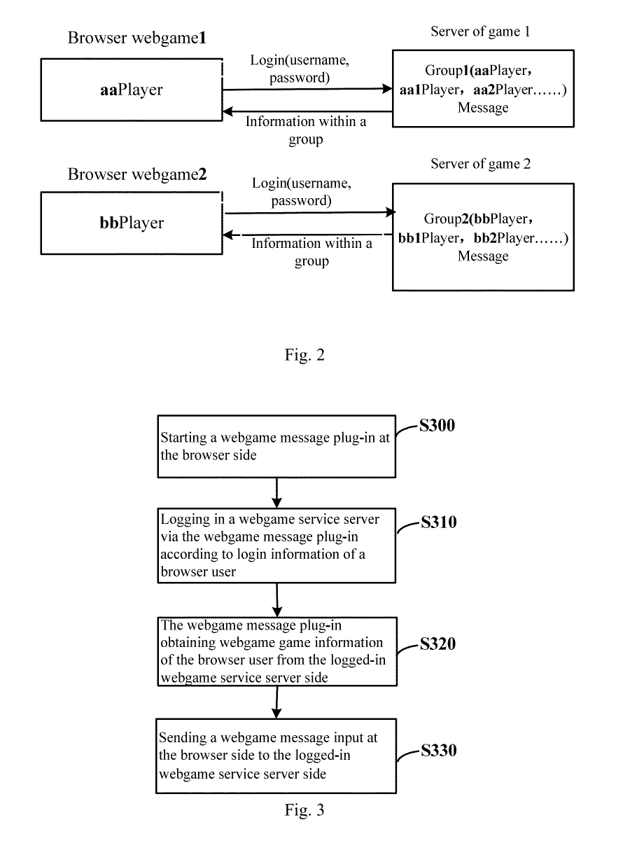

### DETAILED DESCRIPTION OF THE INVENTION

In the following the disclosure will be further described in detail in connection with the particular embodiments and with reference to the drawings, in order to make the objects, technical solutions and advantages of the disclosure more apparent.

In the prior art, sending a message in a webgame is primarily by directly transceiving information between a browser and a game server, and the core in the disclosure lies in the addition of a “webgame service server” which is located at a server side arranged by an operator of the browser. In the webgame service server of the disclosure, it is configured for linking the browser with the game server, and the game server is a game server operated by an existing game developer.

The disclosure proposes a method for a browser to send a webgame message. FIG. 3 is a flow chart of the method according to an embodiment of the disclosure. Referring to FIG. 3, the method comprises the following steps: at step S300, starting a webgame message plug-in at the browser side; at step S310, logging in a webgame service server via the webgame message plug-in according to login information of a browser user; at step S320, the webgame message plug-in obtaining webgame game information of the browser user from the logged-in webgame service server side; and at step S330, according to the webgame game information of the browser user, the webgame message plug-in sending a webgame message input at the browser side to the logged-in webgame service server side.

Therein, in the login information of the browser user is contained a unique identifier of the browser user at the server side, and the webgame game information of the browser user is obtained according to the identifier. The webgame game information is bound to and corresponds to the identifier, the identifier corresponds to one or more game, for example, game 1, game 2, . . . , (game 1 corresponds to a server of game 1, where various game information of the user in the server of game 1 is saved, e.g., the name, role, head portrait, group information, and friend relationship information, etc. of the player), and again in the group information is comprised for example information of other players (here are also comprised the names, roles, head portraits, group information, friend relationship information, etc. of the players mentioned above). The webgame game information sent to the browser side comprises at least one of the name, role, head portrait, friend relationship information, and group information of the player of the user, and a webgame message sent by other game users. The webgame game information of the browser user is synchronized from for example the server of game 1, the server of game 2 and the server of game 3 to the webgame service server.

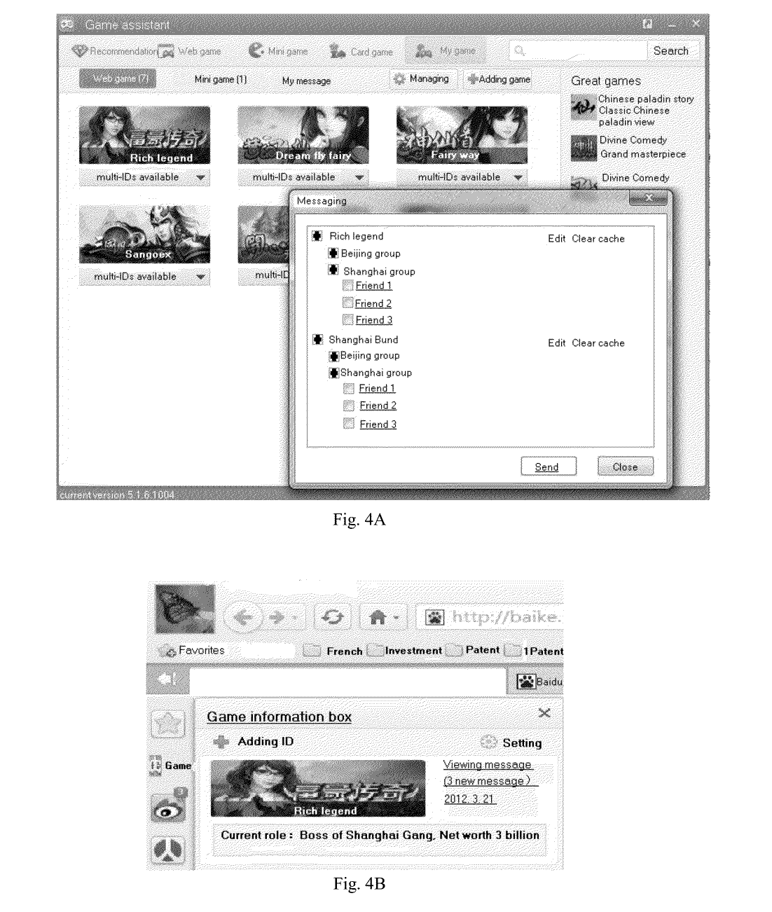

At step S320, after the browser user logs in, the synchronized webgame game information is obtained by the webgame message plug-in from the webgame service server and displayed at the browser side, for example, game 1, group 1, group 2, friend 1, friend 2, . . . , as shown in FIG. 4A, which is an illustration of an interface for inputting a webgame message according to the received webgame game information at the browser side.

At step S330, further, after the browser side obtains the webgame game information, information of a target game user object to which a webgame message is to be sent is determined according to the group information and/or friend relation information and/or the webgame message sent by other game users (the webgame message sent by other game users is a webgame message from at least one game server) therein, webgame message content input by the user is received from the browser side, and the input webgame message content and the determined target game user object information are sent as a webgame message to the logged-in webgame service server side.

Further, in the group information, friend relationship information, and webgame message sent by other game users is carried the identification information of a game user object. The target game user object information comprises the identification information of the target game user object obtained from the group information, friend relationship information, and webgame message sent by other game users. The browser side sends the webgame message content input by the browser user and the obtained identification information of the target game user object as a webgame message to the logged-in webgame service server side.

The browser user inputs a webgame message for example in a way in FIG. 4A, wherein when the browser user clicks the group information and friend information in the webgame game information and selects the objects to which information is to be sent, an edit dialogue may be popped up only by clicking the button “Send information”, and the edit of information to be sent is implemented. In the figure, what is illustrated is to select the name of a friend and group information to be sent.

In a further embodiment of the method, the browser side may not only act as a sender of a webgame message, but may also act as a receiver of a webgame message, which receives a webgame message from other browser user. When receiving a webgame message sent by other browser user, the browser side receives the webgame message in real time if the browser user is in a state in which he has logged in the browser, or displays the webgame message when the browser is started, if he is in a state in which he has not logged in the browser.

When the webgame game information and/or the webgame message is displayed at the browser side, it may be displayed in a popup window of the browser, or displayed in a status bar of the browser, or displayed in a plug-in arranged in the browser. At the browser side may be arranged a prompt display of the amount and time of new information, and the user role, group information, or a preview display of at least a part of the content of new information.

FIG. 4B is an illustration of an interface for receiving a webgame message and prompting it at the browser side. In FIG. 4B, it is only illustratively shown that the module responsible for displaying a message is a browser plug-in arranged in a left box, of course, it may also be a popup window, or a digital marker in a toolbar, and in the figure there are prompted 3 pieces of new information. The sending and display of information needs to be done via the user identifier.

The disclosure further proposes a browser configured to implement the above described method for a browser to send a webgame message.

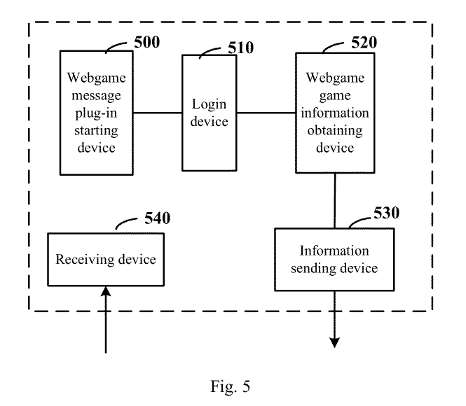

FIG. 5 is a structural block diagram of a browser according to an embodiment of the disclosure. Referring to FIG. 5, the browser comprises: a webgame message plug-in starting device 500 configured to start a webgame message plug-in at the browser side; a login device 510 configured to log in a webgame service server via the webgame message plug-in according to login information of a browser user; a webgame game information obtaining device 520 configured to obtain webgame game information of the browser user via the webgame message plug-in from the logged-in webgame service server side; and an information sending device 530 configured to, according to the webgame game information of the browser user, send a webgame message input at the browser side via the webgame message plug-in to the logged-in webgame service server side.

Therein, in the login information of the browser user is contained a unique identifier of the browser user at the server side, and the webgame game information of the browser user is obtained according to the identifier. The webgame game information is bound to and corresponds to the identifier, and the identifier corresponds to one or more game.

The information sending device 530 further determines information of a target game user object to which a webgame message is to be sent according to the group information and/or friend relation information and/or the webgame message sent by other game users in the webgame game information, receives webgame message content input by the user, and sends the input webgame message content and the determined target game user object information as a webgame message to the logged-in webgame service server side.

Therein, in the group information, friend relationship information, and webgame message sent by other game users is carried the identification information of a game user object. The target game user object information comprises the identification information of the target game user object obtained from the group information, friend relationship information, and webgame message sent by other game users. The information sending device 530 sends the webgame message content input by the browser user and the obtained identification information of the target game user object as a webgame message to the logged-in webgame service server side.

The browser according to a further embodiment of the disclosure further comprises a receiving device 540 configured to receive a webgame message from other browser user. When other browser user sends a webgame message, the receiving device receives the webgame message in real time if the browser user is in a state in which he has logged in the browser, or receives the webgame message when the browser is logged in and triggers the browser to display the webgame message, if the browser user is in a state in which he has not logged in the browser.

When the webgame game information and/or the webgame message is displayed at the browser side, it may be displayed in a popup window of the browser, or displayed in a status bar of the browser, or displayed in a plug-in arranged in the browser. At the browser side may be arranged a prompt display of the amount and time of new information, and the user role, group information, or a preview display of at least a part of the content of new information.

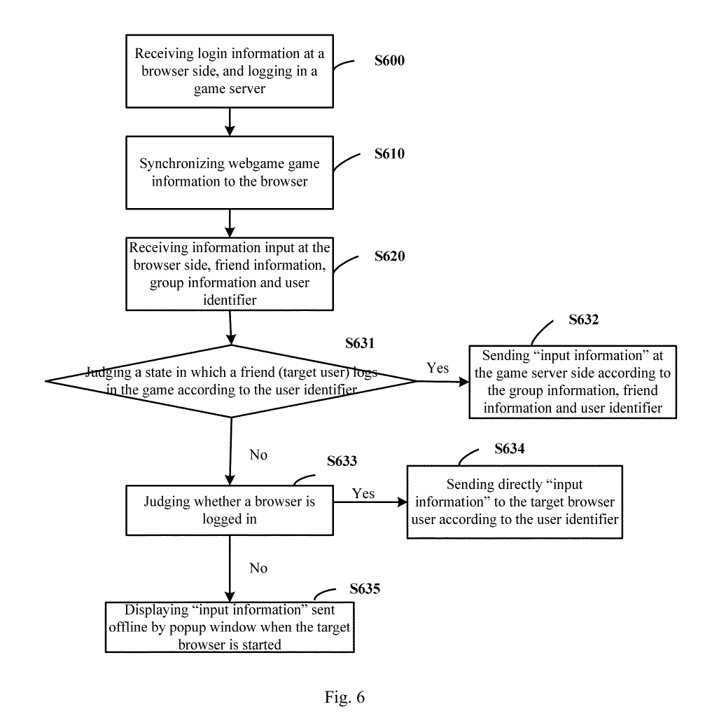

The disclosure further proposes a method for a webgame service server to distribute a webgame message. FIG. 6 is a flow chart of the method according to an embodiment of the disclosure. Referring to FIG. 6, the method comprises the steps of: at step S600, receiving login information of a browser user sent by a browser side, and logging in a game server according to the login information; at step S610, synchronizing webgame game information of the browser user with the game server according to the browser user identification corresponding to the login information of the browser user; at step S620, synchronizing the synchronously obtained webgame game information of the browser user to the browser side which logs in the webgame service server; and at step S630, receiving a webgame message sent by the browser side which logs in the webgame service server, and sending the webgame message to a corresponding target browser side according to the webgame game information of the browser user.

In the login information of the browser user is contained a unique identifier of the browser user at the server side, and the webgame game information of the browser user is obtained according to the identifier. The webgame game information is bound to and corresponds to the identifier, and the identifier corresponds to one or more game. The webgame game information comprises at least one of the name, role, head portrait, friend relationship information, and group information of the player of the user, and a webgame message sent by other game users. The login information of the browser user corresponds to information on at least one game server account, the webgame message sent by other game users is a webgame message from at least one game server, and the browser user account information is bound with the game server account information.

The browser user identification corresponds to multiple games, and each game corresponds to a respective game server. At step S610, according to the browser user identification, individual game servers corresponding to the browser user identification synchronize all the webgame game information of the browser user to the webgame service server.

At step S630, the webgame message received from the browser side comprises webgame message content input by the user and information of a target game user object to which the webgame message is to be sent. In the group information, friend relationship information, and webgame message sent by other game users is carried the identification information of a game user object, and the webgame service server sends a webgame message to a target game user according to the identification information of the target game user object.

Step 630 further comprises the following steps. At step 631, when the webgame message is sent to a corresponding target browser side, it is needed to first judge the login state of a target browser user according to the identification of the target browser user; at step 632, if it is judged that the target browser user has logged in a game server, the webgame message is sent to the target browser user via the game server; at step 633, if it is judged that he has not logged in a game server, it is further judged whether the target browser user has logged in a browser according to the identification of the target browser user; at step 634, if it is judged that the target browser user has logged in a browser and the webgame service server has received a webgame message corresponding to the identification of the target browser user, the webgame message is sent to the corresponding target browser user; and at step 635, if it is judged that the target browser user has not logged in a browser, then the webgame message is stored, and when the login information of the target browser user is received, the webgame message is sent to the target browser user, or the webgame message is sent to a game server in order for the target browser user to be able to receive the webgame message when he logs in the game server.

According to a further embodiment of the method of the disclosure, the browser for sending a webgame message may equally receive a webgame message from other browser user, and if other browser user sends a webgame message to the browser side, the webgame message is sent to the browser side in real time, if the browser user is in a state in which he has logged in the browser, or the webgame message is sent to the browser side when the browser user logs in, if he is in a state in which he has not logged in the browser.

The disclosure further proposes a webgame service server configured to implement the above described method for a webgame service server to distribute a webgame message.

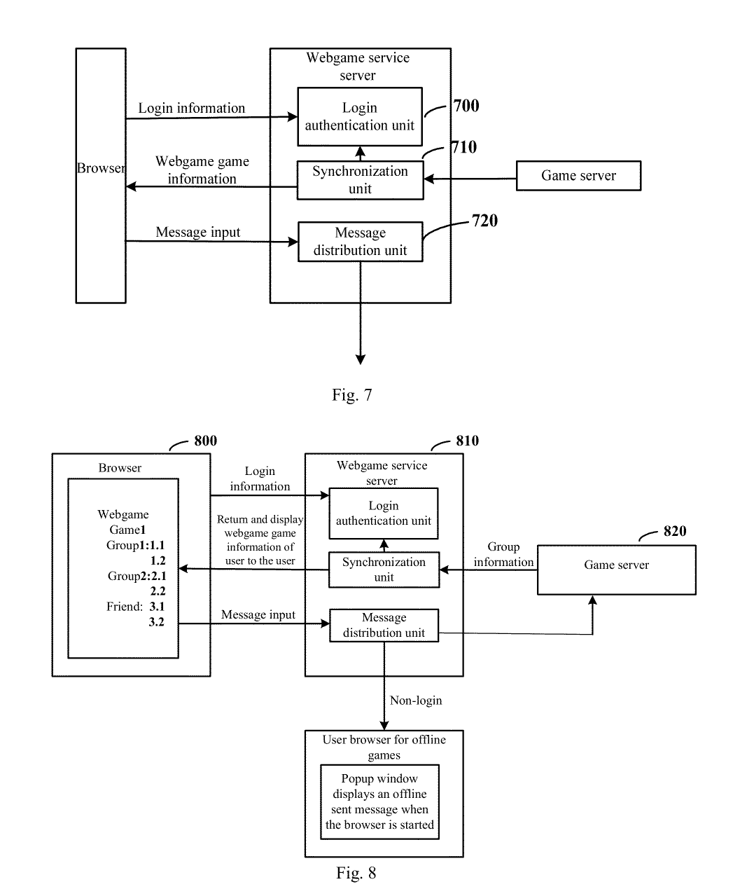

FIG. 7 is a structural block diagram of the webgame service server. Referring to FIG. 7, the webgame service server of the disclosure comprises: a login authentication unit 700 configured to receive login information of a browser user sent by a browser side and authenticating it, and allow the browser user to log in after the authentication is passed; a synchronization unit 710 configured to synchronize webgame game information of the browser user with a game server according to the browser user identification corresponding to the login information of the browser user, and synchronize the synchronously obtained webgame game information of the browser user to the browser side which logs in the webgame service server; and a message distribution unit 720 configured to receive a webgame message sent by the browser side which logs in the webgame service server, and send the webgame message to a corresponding target browser side according to the webgame game information of the browser user.

In the login information of the browser user is contained a unique identifier of the browser user at the server side, and the webgame game information of the browser user is obtained according to the identifier. The webgame game information is bound to and corresponds to the identifier, and the identifier corresponds to one or more game. The webgame game information comprises at least one of the name, role, head portrait, friend relationship information, and group information of the player of the user, and a webgame message sent by other game users. The login information of the browser user corresponds to information on at least one game server account, the webgame message sent by other game users is a webgame message from at least one game server, and the browser user account information is bound with the game server account information.

The browser user identification corresponds to multiple games, and each game corresponds to a respective game server. The synchronization unit 710, according to the browser user identification, synchronizes all the webgame game information of the browser user in individual game servers corresponding to the browser user identification to the webgame service server.

The webgame message received from the browser side by the message distribution unit 720 comprises webgame message content input by the user and information of a target game user object to which the webgame message is to be sent. In the group information, friend relationship information, and webgame message sent by other game users is carried the identification information of a game user object, and the message distribution unit 720 sends a webgame message to a target game user according to the identification information of the target game user object.

Therein, the message distribution unit 720 judges the login state of a target browser user according to the identification of the target browser user, if it is judged that the target browser user has logged in a game server, then sends the webgame message to the target browser user via the game server, or if it is judged that the target browser user has not logged in a game server, then further judges whether the target browser user has logged in a browser according to the identification of the target browser user, and if it is judged that the he has logged in a browser and the webgame service server has received a webgame message corresponding to the identification of the target browser user, the message distribution unit 720 sends the webgame message to the corresponding target browser user. If it is judged that the target browser user has not logged in a browser, then the message distribution unit 720 stores the webgame message, and when the login information of the target browser user is received, sends the webgame message to the target browser user, or sends the webgame message to a game server in order for the target browser user to be able to receive the webgame message when he logs in the game server.

The disclosure further proposes a system for sending a message in a webgame. FIG. 8 is a structural block diagram of the system, which comprises: a browser 800 configured to log in a webgame service server, obtain webgame game information of a browser user from the logged-in webgame service server side, input a webgame message and send it to the logged-in webgame service server side according to the webgame game information of the browser user; the webgame service server 810 configured to receive login information of the browser user sent by the browser side and authenticate it, allow the browser user to log in after the authentication is passed, synchronize webgame game information of the browser user with a game server according to the browser user identification corresponding to the login information of the browser user, and synchronize the synchronously obtained webgame game information of the browser user to the browser side which logs in the webgame service server, receive a webgame message sent by the browser side which logs in the webgame service server, and send the webgame message to a corresponding target browser side according to the webgame game information of the browser user; and the game server 820 configured to synchronize the webgame game information of the user to the webgame service server in real time.

The algorithms and displays provided here are not inherently related to any specific computer, virtual system or other device. Various general-purpose systems may also be used with the teachings herein. According to the above description, the structure required for constructing such systems is obvious. In addition, the disclosure is not directed to any specific programming language. It should be understood that the content of the disclosure described herein may be carried out utilizing various programming languages, and that the above description for a specific language is for the sake of disclosing preferred embodiments of the disclosure.

For a device embodiment, it is described relatively simply due to its substantial similarity to a corresponding method embodiment, and as for its relevant parts reference may be made to the description of the parts of the method embodiment.

The individual embodiments in the specification are described using a progressive manner, each embodiment highlights its difference from other embodiments, and identical or similar parts of the individual embodiments may be referred relative to each other.

Embodiments of the individual components of the disclosure may be implemented in hardware, or in a software module running on one or more processors, or in a combination thereof. It will be appreciated by those skilled in the art that, in practice, some or all of the functions of some or all of the components in a browser client device/webgame service server for sending a webgame message according to individual embodiments of the disclosure may be realized using a microprocessor or a digital signal processor (DSP). The disclosure may also be implemented as an apparatus or device program (e.g., a computer program and a computer program product) for carrying out a part or all of the method as described herein. Such a program implementing the disclosure may be stored on a computer readable medium, or may be in the form of one or more signals. Such a signal may be obtained by downloading it from an Internet website, or provided on a carrier signal, or provided in any other form.

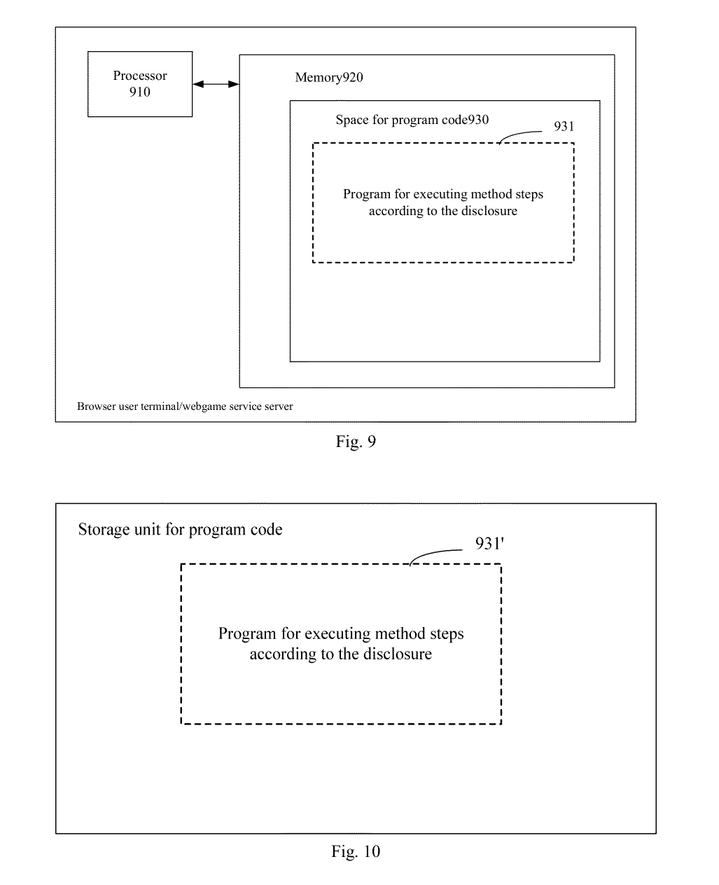

For example, FIG. 9 schematically shows a browser user terminal device/webgame service server which may carry out sending a webgame message according to an embodiment of the disclosure. The user terminal device/webgame service server traditionally comprises a processor 910 and a computer program product or a computer readable medium in the form of a memory 920. The memory 920 may be an electronic memory such as a flash memory, an EEPROM (electrically erasable programmable read-only memory), an EPROM, a hard disk or a ROM. The memory 920 has a memory space 930 for a program code 931 for carrying out any method steps in the methods as described above. For example, the memory space 930 for a program code may comprise individual program codes 931 for carrying out individual steps in the above methods, respectively. The program codes may be read out from or written to one or more computer program product. These computer program products comprise such a program code carrier as a hard disk, a compact disk (CD), a memory card or a floppy disk. Such a computer program product is generally a portable or stationary storage unit as described with reference to FIG. 10. The storage unit may have a memory segment, a memory space, etc. arranged similarly to the memory 920 in the browser user terminal device/webgame service server of FIG. 9. The program code may for example be compressed in an appropriate form. In general, the storage unit comprises a computer readable code 931′, i.e., a code which may be read by e.g., a processor such as 910, and when run by the browser user terminal device/webgame service server, the codes cause the browser user terminal device/webgame service server to carry out individual steps in the methods described above.

“An embodiment”, “the embodiment” or “one or more embodiments” mentioned herein implies that a particular feature, structure or characteristic described in connection with an embodiment is included in at least one embodiment of the disclosure. In addition, it is to be noted that, examples of a phrase “in an embodiment” herein do not necessarily all refer to one and the same embodiment.

In the specification provided herein, a plenty of particular details are described. However, it can be appreciated that an embodiment of the disclosure may be practiced without these particular details. In some embodiments, well known methods, structures and technologies are not illustrated in detail so as not to obscure the understanding of the specification.

It is to be noted that the above embodiments illustrate rather than limit the disclosure, and those skilled in the art may design alternative embodiments without departing the scope of the appended claims. In the claims, any reference sign placed between the parentheses shall not be construed as limiting to a claim. The word “comprise” does not exclude the presence of an element or a step not listed in a claim. The word “a” or “an” preceding an element does not exclude the presence of a plurality of such elements. The disclosure may be implemented by means of a hardware comprising several distinct elements and by means of a suitably programmed computer. In a unit claim enumerating several devices, several of the devices may be embodied by one and the same hardware item. Use of the words first, second, and third, etc. does not mean any ordering. Such words may be construed as naming.

Furthermore, it is also to be noted that the language used in the description is selected mainly for the purpose of readability and teaching, but not selected for explaining or defining the subject matter of the disclosure. Therefore, for those of ordinary skills in the art, many modifications and variations are apparent without departing the scope and spirit of the appended claims. For the scope of the disclosure, the disclosure of the disclosure is illustrative, but not limiting, and the scope of the disclosure is defined by the appended claims.

1. A method for a browser to send a webgame message, the method comprising:
starting a webgame message plug-in at the browser side;
logging in a webgame service server via the webgame message plug-in according to login information of a browser user;
the webgame message plug-in obtaining webgame game information of the browser user from the logged-in webgame service server side; and
the webgame message plug-in sending a webgame message input at the browser side to the logged-in webgame service server side according to the webgame game information of the browser user.

2. The method as claimed in claim 1, wherein in the login information of the browser user is contained a unique identifier of the browser user at the server side, and the webgame game information of the browser user is obtained according to the identifier.

3. The method as claimed in claim 2, wherein the webgame game information is bound to and corresponds to the identifier, and the identifier corresponds to one or more game.

4. The method as claimed in claim 1, wherein the method further comprises the step of: the browser side receiving a webgame message from other browser users; and
wherein when receiving a webgame message sent by other browser users, the browser side receives the webgame message in real time if the browser user is in a state in which he has logged in the browser.

5. (canceled)

6. The method as claimed in claim 4, wherein when receiving a webgame message sent by other browser users, the browser side displays the webgame message when the browser is started, if the browser user is in a state in which he has not logged in the browser.

7. (canceled)

8. The method as claimed in claim 1, wherein the webgame game information comprises at least one of the name, role, head portrait, friend relationship information, and group information of the player of the user, and a webgame message sent by other game users; and
the webgame message plug-in sending a webgame message input at the browser side to the logged-in webgame service server side according to the webgame game information of the browser user comprises:
after the browser side obtains the webgame game information, determining information of a target game user object to which a webgame message is to be sent according to the group information and/or friend relation information and/or the web game message sent by other game users therein;
receiving webgame message content input by the user, and sending the input webgame message content and the determined target game user object information as a webgame message to the logged-in webgame service server side.

9. (canceled)

10. The method as claimed in claim 8, wherein in the group information, friend relationship information, and webgame message sent by other game users is carried the identification information of a game user object;
the determining information of a target game user object to which a webgame message is to be sent comprises:
obtaining the identification information of the target game user object from the group information, friend relationship information, and webgame message sent by other game users; and
the sending the input webgame message content and the determined target game user object information as a webgame message to the logged-in webgame service server side comprises:
sending the input webgame message and the obtained identification information of the target game user object as a webgame message to the logged-in webgame service server side.

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. A method for a webgame service server to distribute a webgame message, comprising the steps of:
receiving login information of a browser user sent by a browser side, and logging in the webgame service server according to the login information;
synchronizing webgame game information of the browser user with a game server according to the browser user identification corresponding to the login information of the browser user;
synchronizing the synchronously obtained webgame game information of the browser user to the browser side which logs in the webgame service server; and
receiving a webgame message sent by the browser side which logs in the webgame service server, and sending the webgame message to a corresponding target browser side according to the webgame game information of the browser user.

28. The method as claimed in claim 27, wherein in the login information of the browser user is contained a unique identifier of the browser user at the server side, and the webgame game information of the browser user is obtained according to the identifier; and
the web game game information is bound to and corresponds to the identifier, and the identifier corresponds to one or more game.

29. (canceled)

30. The method as claimed in claim 27, wherein the method further comprises the step of: sending a webgame message from other browser users to the browser side; and
if other browser users send a webgame message to the browser side, the webgame message is sent to the browser side in real time if the browser user is in a state in which he has logged in the browser.

31. (canceled)

32. The method as claimed in claim 30, wherein if other browser users send a webgame message to the browser side, the webgame message is sent to the browser side when the browser user logs in, if the browser user is in a state in which he has not logged in the browser.

33. (canceled)

34. (canceled)

35. (canceled)

36. (canceled)

37. (canceled)

38. The method as claimed in claim 27, wherein the browser user identification corresponds to multiple games, each game corresponds to a respective game server, and according to the browser user identification, individual game servers corresponding to the browser user identification synchronize all the webgame game information of the browser user to the webgame service server.

39. The method as claimed in claim 27, wherein the method further comprises:
judging the login state of a target browser user according to the identification of the target browser user, if it is judged that the target browser user has logged in a game server, then sending the webgame message to the target browser user via the game server, or if he has not logged in a game server, then further judging whether the target browser user has logged in a browser according to the identification of the target browser user, and if he has logged in a browser and the webgame service server has received a webgame message corresponding to the identification of the target browser user, sending the webgame message to the corresponding target browser user.

40. The method as claimed in claim 39, wherein the method further comprises: if the target browser user has not logged in a game server, then further judging whether the target browser user has logged in a browser according to the identification of the target browser user, and if he has not logged in a browser, then storing the webgame message, and when the login information of the target browser user is received, sending the webgame message to the target browser user, or sending the webgame message to a game server in order for the target browser user to be able to receive the webgame message when he logs in the game server.

41. A webgame service server, comprising:
at least one processor to execute a plurality of units comprising
a login information authentication unit to receive login information of a browser user sent by a browser side and authenticate it, and allow the browser user to log in after the authentication is passed;
a synchronization unit to synchronize webgame game information of the browser user with a game server according to the browser user identification corresponding to the login information of the browser user, and synchronize the synchronously obtained webgame game information of the browser user to the browser side which logs in the webgame service server; and
a message distribution unit to receive a webgame message sent by the browser side which logs in the webgame service server, and send the webgame message to a corresponding target browser side according to the webgame game information of the browser user.

42. The webgame service server as claimed in claim 41, wherein in the login information of the browser user is contained a unique identifier of the browser user at the server side, and the webgame game information of the browser user is obtained according to the identifier; and
the web game game information is bound to and corresponds to the identifier, and the identifier corresponds to one or more game.

43. (canceled)

44. The webgame service server as claimed in claim 42, wherein the message distribution unit sends a webgame message from other browser users to the browser side; and
if other browsers user send a web game message to the browser side, the message distribution unit sends the web game message to the browser user in real time if the browser user is in a state in which he has logged in the browser.

45. (canceled)

46. The webgame service server as claimed in claim 44, wherein if other browser users send a webgame message to the browser side, the message distribution unit sends the webgame message to the browser side when the browser user logs in, if the browser user is in a state in which he has not logged in the browser.

47. (canceled)

48. (canceled)

49. (canceled)

50. (canceled)

51. (canceled)

52. The webgame service server as claimed in claim 41, wherein the browser user identification corresponds to multiple games, each game corresponds to a respective game server, and according to the browser user identification, individual game servers corresponding to the browser user identification synchronize all the webgame game information of the browser user to the webgame service server.

53. The webgame service server as claimed in claim 41, wherein the message distribution unit judges the login state of a target browser user according to the identification of the target browser user, if it is judged that the target browser user has logged in a game server, then sends the webgame message to the target browser user via the game server, or if it is judged that the target browser user has not logged in a game server, then further judges whether the target browser user has logged in a browser according to the identification of the target browser user, and if he has logged in a browser and the webgame service server has received a webgame message corresponding to the identification of the target browser user, the message distribution unit sends the webgame message to the corresponding target browser user.

54. (canceled)

55. (canceled)

56. (canceled)

57. (canceled)
